(19) United States
(12) Patent Application Publication
(10) Pub. No.: US 2018/0329527 A1
(43) Pub. Date: Nov. 15, 2018

(54) METHOD AND ELECTRONIC DEVICE FOR CHARGING PEN

(71) Applicant: Samsung Electronics Co., Ltd., Suwon-si (KR)

(72) Inventors: Changbyung PARK, Suwon-si (KR); Joohoon LEE, Yongin-si (KR); Byunghoon KANG, Suwon-si (KR); Juwan PARK, Seongnam-si (KR)

(21) Appl. No.: 15/977,917

(22) Filed: May 11, 2018

(30) Foreign Application Priority Data
May 11, 2017 (KR) 10-2017-0058839

(51) Int. Cl. G06F 3/0354; G06F 3/038; H02J 50/12; H02J 7/00

(52) U.S. Cl. CPC G06F 3/03545; G06F 3/0383; G06F 2203/0384; H02J 7/0044; H02J 50/12

(57) ABSTRACT

Various embodiments of the present disclosure relate to a method for charging a pen, and the pen may include: a resonance circuit unit that resonates with an electromagnetic field formed in an electronic device to output a resonance signal; a switch control unit that, when the intensity of the resonance signal exceeds an intensity of a first reference range, outputs a signal corresponding to a first level range; and a switch unit that connects the resonance circuit unit and a battery in response to reception of the signal corresponding to the first level range. Various embodiments in addition thereto are also possible.

### CROSS-REFERENCE TO RELATED APPLICATIONS AND CLAIM OF PRIORITY

This application is based on and claims priority under 35 U.S.C. § 119 to Korean Patent Application No. 10-2017-0058839 filed on May 11, 2017 in the Korean Intellectual Property Office, the disclosure of which is incorporated herein by reference in its entirety.

### BACKGROUND

### 1. Field

Various embodiments of the present disclosure relate to a method and an electronic device for charging a pen.

### 2. Description of Related Art

The above information is presented as background information only to assist with an understanding of the present disclosure. No determination has been made, and no assertion is made, as to whether any of the above might be applicable as prior art with regard to the present disclosure.

With the development of a digital technology, electronic devices, such as a smart phone, a notebook, a Personal Digital Assistant (PDA) which can process information, has propagated. An electronic device provides various functions including photographing and web searching, as well as services including a voice call and a text message and has become smaller in its size to enhance the portability thereof. As an electronic device reduced in size, there is a growing interest in an electronic device having a touch screen which can provide an input function and an output function together to efficiently use a limited space.

In detecting a user input, an electronic device having a touch screen may detect a user input by detecting a user body (e.g. a finger) touch, approach, or pressure on the touch screen, or detect a touch of a pen (e.g. a stylus pen or an electronic pen) enabling a more precise input.

### SUMMARY

A passive scheme in which a pen does not include a battery inside and an active scheme in which a pen includes a battery inside are used for a pen.

A passive-type pen does not have a battery therein, and therefore, it is hard for the pen to smoothly supply power to hardware that performs an additional function instead of an input function. Accordingly, it is difficult for the passive-type pen to provide an additional function in addition to an input function.

In contrast, an active-type pen uses a battery included therein to supply power to hardware that performs an additional function instead of an input function and thus has an advantage of providing an additional function in addition to an input function. An active-type pen may use a contact charging scheme or a wireless charging scheme to charge a battery included therein. However, an active-type pen using a contact charging scheme may have a problem of abrasion, oxidation, or corrosion of a contact part for charging, through outside exposure of the contact part. An active-type pen using a wireless charging scheme further includes a separate wireless charging coil for performing a wireless charging function and thus mounting of additional hardware on the pen having a limited inner space may be difficult. In addition, when an electronic device does not have a separate tool and circuit for charging an active-type pen, the pen requires a separate charging accessory (e.g. a charging dock, a case providing a charging function) for charging the battery of the pen. Therefore, a user may feel inconvenience.

Various embodiments of the present disclosure may provide a method and device for charging a battery included in a pen by using a resonance signal generated in the pen.

According to various embodiments of the present disclosure, a pen including a battery may include: a resonance circuit unit that resonates with an electromagnetic field formed in an electronic device to output a resonance signal; a switch control unit that, when the intensity of the resonance signal exceeds an intensity of a first reference range, outputs a signal corresponding to a first level range; and a switch unit that connects the resonance circuit unit and the battery in response to reception of the signal corresponding to the first level range.

According to various embodiments of the present disclosure, an electronic device may include: a detecting sensor that includes at least one coil and generates and outputs a detecting signal according to whether a pen is housed in a housing space of the electronic device by using the at least one coil; and a processor configured to determine whether the pen is housed at least on the basis of the detecting signal of the detecting sensor, and when the pen is housed in the electronic device, apply a signal the at least one coil included in the detecting sensor to charge the pen.

A method and an electronic device for charging a pen according to various embodiments uses a resonance signal generated in the pen to charge a battery (or a super capacitor) included in the pen, and thus can provide an input function of the pen and a charging function of the battery by means of a single coil.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a conceptual diagram illustrating an electronic device including a touch panel and a pen according to various embodiments of the present disclosure;

FIG. 2 illustrates an example of a block diagram of a pen according to various embodiments of the present disclosure;

FIG. 3 illustrates a graph showing a change of a resonance frequency according to battery charging in a pen according to various embodiments of the present disclosure;

FIG. 4 illustrates an example of a circuit diagram of a pen according to various embodiments of the present disclosure;

FIG. 5 illustrates an example of a signal output from each of elements of a pen according to various embodiments of the present disclosure;

FIG. 6 illustrates another example of a block diagram of a pen according to various embodiments of the present disclosure;

FIG. 7 illustrates another example of a circuit diagram of a pen according to various embodiments of the present disclosure;

FIG. 8 illustrates another example of a signal output from each of elements of a pen according to various embodiments of the present disclosure;

FIG. 9 illustrates yet another example of a block diagram of a pen according to various embodiments of the present disclosure;

FIG. 10 illustrates yet another example of a circuit diagram of a pen according to various embodiments of the present disclosure;

FIG. 11 illustrates yet another example of a signal output from each of elements of a pen according to various embodiments of the present disclosure;

FIG. 12 illustrates a block diagram of an electronic device according to various embodiments of the present disclosure;

FIG. 13 illustrates a specific configuration of a pen sensor according to various embodiments of the present disclosure;

FIGS. 14A and 14B illustrate a specific configuration of a detecting sensor according to various embodiments of the present disclosure;

FIG. 15 illustrates an example of a flowchart of charging a battery of a pen in an electronic device according to various embodiments of the present disclosure;

FIG. 16 illustrates another example of a flowchart of charging a battery of a pen in an electronic device according to various embodiments of the present disclosure; and

FIG. 17 illustrates a screen displaying a UI representing that charge is required in an electronic device according to various embodiments of the present disclosure.

### DETAILED DESCRIPTION

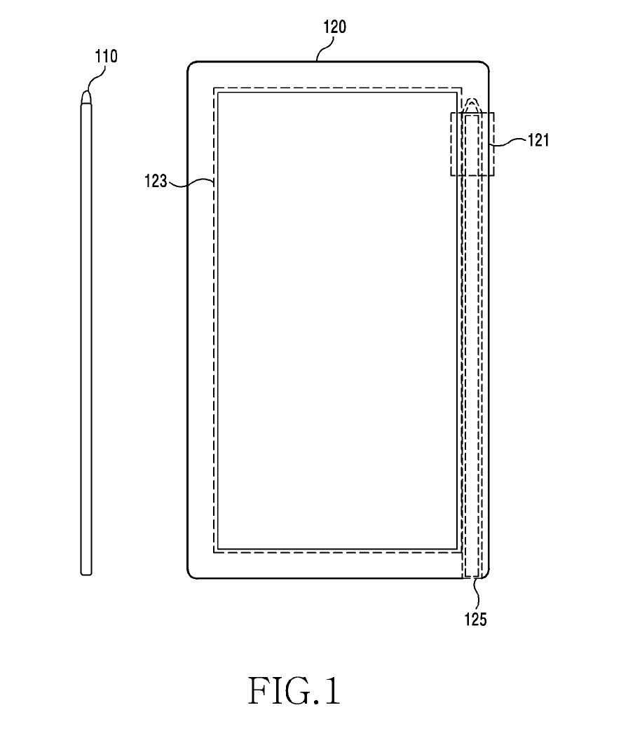

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar elements. A singular expression may include a plural expression unless they are definitely different in a context. In the present disclosure, the expression “A or B” or “at least one of A and/or B” may include all possible combination of items listed together. The expression “a first”, “a second”, “the first”, or “the second” may modify the corresponding elements regardless of the order or the importance, and is merely used for discriminating one element from another element and does not limit the corresponding elements. When an element (e.g., first element) is referred to as being “(functionally or communicatively) connected,” or “directly coupled” to another element (second element), the element may be connected directly to the another element or connected to the another element through yet another element (e.g., third element).

The expression “adapted (configured) to” as used in the present disclosure may be interchangeably used with, for example, “suitable for”, “having the capacity to”, “modified to”, “made to”, “capable of”, or “designed to” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) for performing the corresponding operations or a generic-purpose processor (e.g. CPU or Application Processor) that can perform the corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type circuit. In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a media box (e.g., Samsung HomeSync™, Apple TV′, or Google TV™), a game console (e.g., Xbox™ and PlayStation™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, a imaging machine, and an ultrasonic machine), a navigation device, a Global Navigation Satellite System (GNSS), an Event Data Recorder (EDR), a Flight Data Recorder (FDR), a Vehicle Infotainment Devices, an electronic devices for a ship (e.g. a navigation device for a ship, and a gyro-compass), avionics, security devices, an automotive head unit, a robot for home or industry, a drone, an automatic teller's machine (ATM) in financial institutions, point of sales (POS) in a shop, or internet device of things (e.g., a light bulb, various sensors, a sprinkler device, a fire alarm, a thermostat, a streetlamp, a toaster, a sporting goods, a hot water tank, a heater, a boiler, etc.). According to some embodiments, an electronic device may include at least one of a part of furniture, a building/structure, or a vehicle, an electronic board, an electronic signature receiving device, a projector, and various types of measuring instruments (e.g., a water meter, an electric meter, a gas meter, a radio wave meter, and the like). In various embodiments, the electronic device may be flexible, or may be a combination of two or more of the aforementioned various devices. The electronic device according to one embodiment of the present disclosure is not limited to the above described devices. In the present disclosure, the term “user” may indicate a person using an electronic device or a device (e.g., an artificial intelligence electronic device) using an electronic device.

FIG. 1 illustrates a conceptual diagram illustrating an electronic device including a touch panel and a pen according to various embodiments of the present disclosure.

According to various embodiments, a pen 110 (e.g. a stylus pen or an electronic pen) may operate in a passive scheme (e.g. an electromagnetic resonance scheme). When the pen 110 operating in a passive scheme contacts a touch panel 123 or approaches (hovers) the touch panel 123, the pen 110 may generate a resonance signal by resonating with an electromagnetic field periodically formed in the touch panel 123. According to an embodiment, the pen 110 may include an active circuit configured to provide a function (e.g. a function determining whether the pen is being used, and a function identifying the battery power level of the pen) separate from an input function, and a battery configured to supply power to the active circuit. The pen 110 may charge the battery using a resonance signal generated by resonating with an electromagnetic field periodically formed in an electronic device 120. For example, when the pen 110 is housed in a housing space 125 of the electronic device 120, the pen 110 may generate a resonance signal to detect whether the pen 110 has been housed in the housing space 125, by resonating with an electromagnetic field periodically formed in a detecting sensor 121. When a resonance signal is generated, the pen 110 may charge the battery using the resonance signal. In another example, when the pen 110 contacts the touch panel 123 of the electronic device 120 or approaches (hovers) the touch panel 123, the pen 110 may generate a resonance signal by resonating with an electromagnetic field formed in the touch panel 123. When a resonance signal is generated, the pen 110 may charge the battery using the resonance signal. According to an embodiment, the pen 110 may use the active circuit to provide battery information of the pen 110 to the electronic device 120 so as to allow a user to identify whether the battery is required to be charged.

According to various embodiments, the electronic device 120 may include the touch panel 123, the housing space 125 that houses the pen 110, and the detecting sensor 121 that determines whether the pen 110 is housed.

According to various embodiments, the touch panel 123 may include a first coil group disposed in a first direction and a second coil group disposed in a second direction to detect the coordinates of a point which the pen 110 has contacted. The first coil group and the second coil group may be orthogonal to each other, and each of the coil groups may include a plurality of coils. At least one coil of the plurality of coils included in the first and the second coil group may generated an electromagnetic field by receiving a signal during a signal transmission interval (TX interval). At least one coil of the plurality of coils included in the first and the second coil group may receive a response signal of the pen 110 during a signal reception interval (RX interval). The electronic device 120 may identify the coordinates of a point which the pen 110 has contacts, on the basis of the received response signal. According to an embodiment, when the movement of the pen 110 is not detected during a specified time interval in the state of the pen 110 has contacted the touch panel 123, the electronic device 120 may operate in a charging mode of changing the time interval or the period, in which a signal is applied to a coil corresponding to a point which the pen 110 has contacted among the plurality of coils included in the touch panel 123, or the intensity of the applied signal, in order to further efficiently charge the battery of the pen 110. According to an embodiment, when the battery power level of the pen 110 is less than a battery power level (e.g. a reference battery power level) of a specified range, the electronic device 120 may induce a user to charge the battery of the pen 110 by displaying, on the touch panel 123, a User Interface (UI) representing that the pen 110 is required to be charged. According to an embodiment, when a separate charging coil configured to charge the battery of the pen 110 is included in the touch panel 123, the electronic device 120 may display a User Interface (UI) representing that the pen 110 is required to be charged, on the position of the charging coil. When the pen 110 contacts the position at which the UI is displayed, the electronic device 120 may charge the battery of the pen 110 by applying a signal to the charging coil.

According to various embodiments, the housing space 125 is a space in which the pen 110 is housed, and may include the detecting sensor 121 that determines whether the pen 110 is housed. The detecting sensor 121 may include at least one coil and may periodically apply a signal to the at least one coil to form an electromagnetic field so as to determine whether the pen 110 has been housed in the housing space 125. The detecting sensor 121 may receive a response signal (e.g. resonance signal) generated by an electromagnetic field from the pen 110. The electronic device 120 may detect that the pen 110 has been housed in the housing space 125 on the basis of a response signal received through the detecting sensor 121. According to an embodiment, when the pen 110 has been housed in the housing space 125, the electronic device 120 may modify the time interval or the period in which a signal is applied to the at least one coil included in the detecting sensor 121, or the intensity of the applied signal, in order to further efficiently charge the battery of the pen 110.

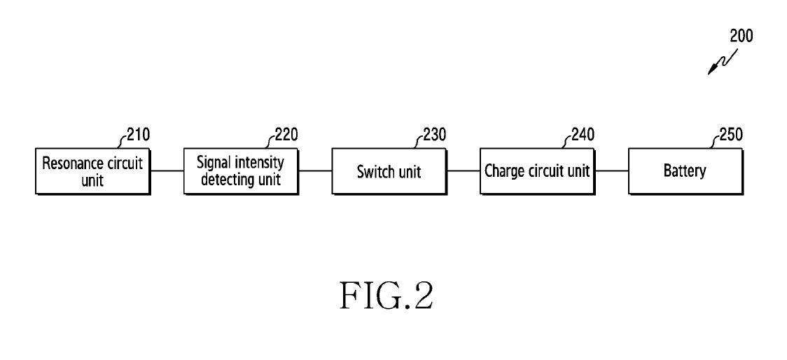

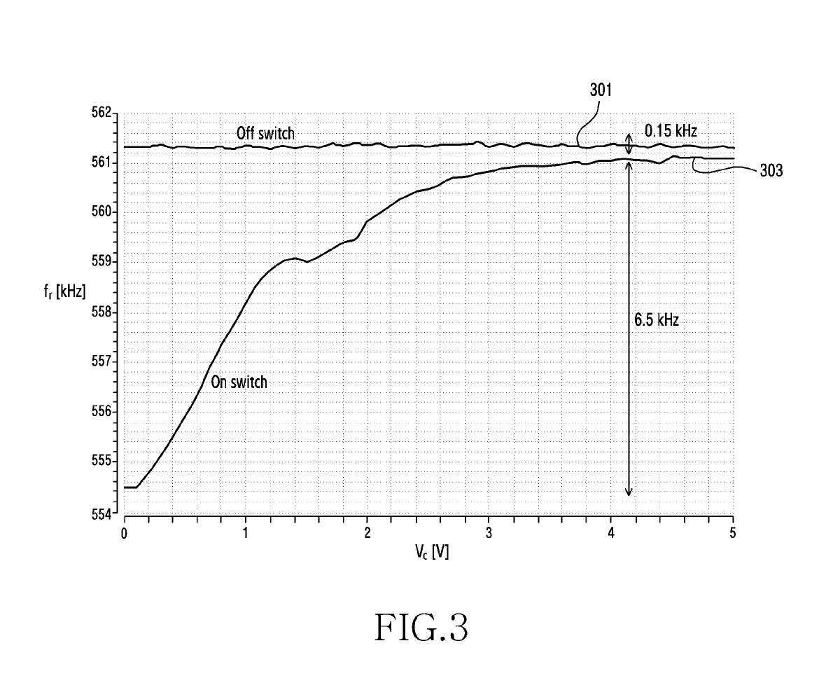

FIG. 2 illustrates an example of a block diagram of a pen according to various embodiments of the present disclosure. FIG. 3 illustrates a graph showing a change of a resonance frequency according to battery charging in another pen according to various embodiments of the present disclosure. Hereinafter, a pen may include the entirety or a part of the pen 110 of FIG. 1.

Referring to FIG. 2, a pen 200 (e.g. the pen 110) may include at least one among a resonance circuit unit 210, a signal intensity detecting unit 220, a switch unit 230, a charge circuit unit 240, and a battery 250 (e.g. a super capacitor).

According to various embodiments, the resonance circuit unit 210 may generate a resonance signal by resonating with an electromagnetic field formed in an electronic device (e.g. the electronic device 120). For example, when the pen 200 is in contact with a touch panel (e.g. the touch panel 123) of the electronic device, the resonance circuit unit 210 may generate a resonance signal by resonating with an electromagnetic field periodically formed in the touch panel. In another example, when the pen 200 is housed in a housing space (e.g. the housing space 125) of the electronic device, the resonance circuit unit 210 may generate a resonance signal by resonating with an electromagnetic field periodically formed in a detecting sensor (e.g. the detecting sensor 121) disposed in the housing space. According to an embodiment, the resonance circuit unit 210 may further include a variable capacitor, the capacitance of which changes depending on a pen pressure, in order to measure the pen pressure of the pen 200.

According to various embodiments, in order to supply power to the battery in the case where the pen 200 has been housed in the housing space of the electronic device, the signal intensity detecting unit 220 may output a control signal to the switch unit 230 on the basis of whether the pen 200 has been housed in the housing space of the electronic device. When the resonance circuit unit 210 is connected to the charge circuit unit 240 and the battery 250 (e.g. a switch is on), as shown in FIG. 3, a response frequency 303 generated in the resonance circuit unit 210 may decrease less than a resonance frequency 301 generated when the resonance circuit unit 210 is not connected to the charge circuit unit 240 and the battery 250 (e.g. a switch is off). Therefore, when the pen 200 performs an input function in the state where the resonance circuit unit 210 is connected to the charge circuit unit 240 and the battery 250, a problem (e.g. ink leakage phenomenon) in that the pen 200 may malfunction by recognizing contact with the touch panel of the electronic device even when the pen is not in contact therewith may occur. In order to prevent the malfunction problem, the signal intensity detecting unit 220 may output different control signals depending on the intensity of a resonance signal to allow the resonance circuit unit 210 to be connected to the charge circuit unit 240 and the battery 250 only when the pen 200 has been housed in the housing space of the electronic device. For example, the signal intensity detecting unit 220 may output, to the switch unit 230, a control signal (e.g. a signal corresponding to a second level range) configured to control the switch unit 230 to prevent the battery 250 from being charged during an interval during which the intensity of a resonance signal generated in the resonance circuit unit 210 is equal to or lower than an intensity Vth1 of a first reference range. In another example, the signal intensity detecting unit 220 may output, to the switch unit 230, a control signal (e.g. a signal corresponding to a first level range) configured to control the switch unit 230 to allow the battery 250 to be charged during an interval during which the intensity of a detected resonance signal exceeds the intensity Vth1 of a first reference range.

According to various embodiments, the switch unit 230 may perform a switch function of connecting the resonance circuit unit 210 with the charge circuit unit 240 and the battery 250, or blocking the connection therebetween on the basis of a control signal received from the signal intensity detecting unit 220. For example, when a signal corresponding to a second level is received from the signal intensity detecting unit 220, the switch unit 230 may block connection to prevent the resonance circuit unit 210 from being connected to the charge circuit unit 240 and the battery 250. In another example, when a signal corresponding to a first level is received from the signal intensity detecting unit 220, the switch unit 230 may connect the resonance circuit unit 210 to the charge circuit unit 240 and the battery 250.

According to various embodiments, when the charge circuit unit 240 is connected to the resonance circuit unit 210, the charge circuit unit 240 may rectify a resonance signal generated in the resonance circuit unit 210 into a direct current signal and provide the rectified signal to the battery 250 to charge the battery 250.

According to various embodiments, the pen 200 may further include an active circuit unit (not illustrated) configured to provide an additional function in addition to an input function. The active circuit unit may include, for example, an optical sensor, a touch sensor, an acceleration sensor, a battery power level sensing sensor, or a communication module. According to an embodiment, when the active circuit unit includes a battery power level sensing sensor and a communication module, the pen 200 may provide the electronic device with information relating to the battery 250 of the pen 200. For example, the pen 200 may use the battery power level sensing sensor to obtain information relating to the power level of the battery 250 and may periodically transmit information relating to the power level of the battery 250 through the communication module to the electronic device. In another example, the pen 200 may determine whether the power level of the battery 250 is lower than a battery power level (e.g. a reference battery power level) of a specified range through the battery power level sensing sensor, and when the power level of the battery 250 is lower than the battery power level of a specified range, may transmit, to the electronic device, a signal notifying that the battery 250 is required to be charged. For example, when information about the power level of the battery 250 is received from the pen 200, the electronic device may determine whether the power level of the battery 250 is lower than a battery power level of a specified range. When the power level of the battery 250 is lower than the battery power level of the specified range, the electronic device may provide a user with information notifying that the pen 200 is required to be charged. For example, the electronic device may provide a user with information (e.g. visual information using a UI or an LED, haptic information including vibration, sound information including an alarm sound) notifying that the pen 200 is required to be charged. In another example, when a signal notifying the battery 250 is required to be charged is received from the pen 200, the electronic device may provide a user with information notifying that the pen 200 is required to be charged.

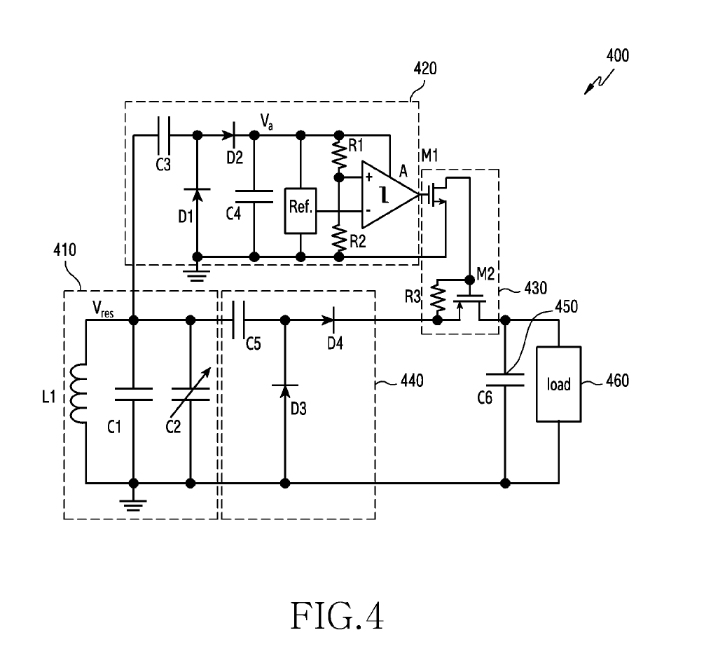

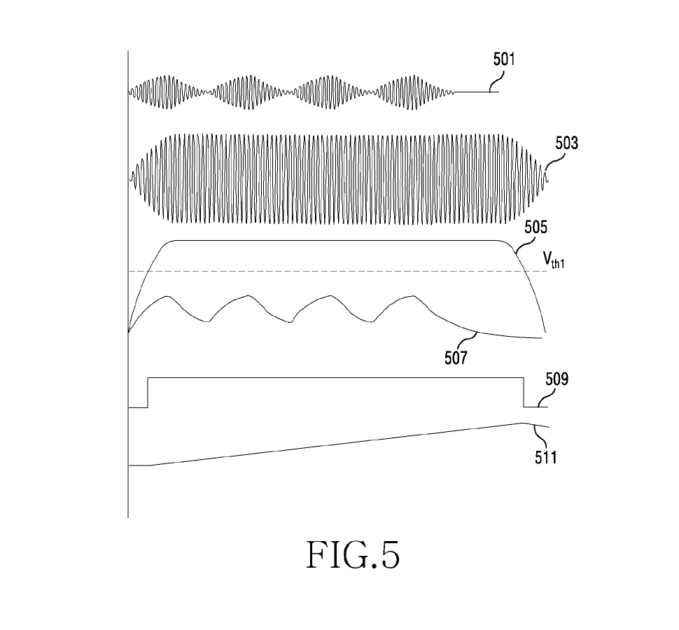

FIG. 4 illustrates an example of a circuit diagram of a pen according to various embodiments of the present disclosure. FIG. 5 illustrates an example of a signal output from each of elements of a pen according to various embodiments of the present disclosure. Hereinafter, a pen may include the entirety or a part of the pen 200 of FIG. 2.

Referring to FIG. 4, a pen 400 (e.g. the pen 110) may include a resonance circuit 410 (e.g. the resonance circuit unit 210), a signal intensity detecting circuit 420 (e.g. the signal intensity detecting unit 220), a switch circuit 430 (e.g. the switch unit 230), a charge circuit 440 (e.g. the charge circuit unit 240), a super capacitor 450 (e.g. the battery 250), and an active circuit 460.

According to various embodiments, the resonance circuit 410 may include at least one among an inductor L1, a first capacitor C1, and a second capacitor (variable capacitor) C2, and when the pen 400 contacts a touch panel (e.g. the touch panel 123) of an electronic device, may generate a resonance signal by resonating with an electromagnetic field formed in the touch panel of the electronic device. For example, when the pen 400 contacts the touch panel of the electronic device, the resonance circuit 410 may generate a first resonance signal 501 as shown in FIG. 5 by resonating with an electromagnetic field periodically formed in the touch panel. In another example, when the pen 400 is housed in a housing space (e.g. the housing space 125) of the electronic device, the resonance circuit 410 may generate a second resonance signal 503 by resonating with an electromagnetic field periodically formed in a detecting module disposed in the housing space.

According to various embodiments, the signal intensity detecting circuit 420 may receive a resonance signal output from the resonance circuit 410 and may include at least one among a third capacitor C3, a fourth capacitor C4, a first diode D1, a second diode D2, a first reference voltage generating element Ref, a first resistor R1, a second resistor R2, and a OP amp A. The third capacitor C3, the first diode D1, and the second diode D2 may rectify a resonance signal generated in the resonance circuit 410 into a direct current signal. The fourth capacitor C4 may be charged by the rectified direct current signal, and a voltage may be applied to the first resistor R1 and the second resistor R2 by the rectified direct current signal and the fourth capacitor C4. When a voltage applied to the second resistor R2 is higher than the voltage of the first reference voltage element Ref, the OP amp A may output a signal corresponding to a first level range, and when a voltage applied to the second resistor R2 is equal to or lower than the voltage of the first reference voltage element Ref, the OP amp A may output a signal corresponding to a second level range lower than the first level range. For example, when the first resonance signal 501 is generated in the resonance circuit 410, the OP amp A may compare a voltage 507 applied to the second resistor R2 with the voltage Vth1 of the first reference voltage element Ref. When the voltage 507 applied to the second resistor R2 is less than the voltage Vth1 of the first reference voltage element Ref during the entire interval as shown in FIG. 5, the OP amp A may output a signal corresponding to the second level range during the entire interval. In another example, when the second resonance signal 503 is generated in the resonance circuit 410, the OP amp A may output a signal 509 corresponding to the first level range during an interval in which a voltage 505 applied to the second resistor R2 is higher than the voltage Vth1 of the first reference voltage element Ref.

According to various embodiments, the switch circuit 430 may receive a signal output from the signal intensity detecting circuit 420 and may include at least one among an n-channel MOSFET M1, a p-channel MOSFET M2, and a third resistor R3. When a signal corresponding to the first level range is output in the signal intensity detecting circuit 420, the n-channel MOSFET M1 may be operated by a gate thereof to which a voltage higher than that of a source thereof is applied. In this case, the source and a drain of the n-channel MOSFET M1 may be electrically connected to each other. When the n-channel MOSFET M1 is operated, a current flows in the third resistor R3 and thus a voltage is applied thereto. Accordingly, a voltage higher than that of a gate of the p-channel MOSFET M2 is applied to a source thereof to operate the p-channel MOSFET M2. In this case, the source and a drain of the p-channel MOSFET M2 is electrically connected to each other, and thus the resonance circuit 410 may be connected to the charge circuit 440 and the super capacitor 450. When a signal corresponding to the second level range is output in the signal intensity detecting circuit 420, the n-channel MOSFET M1 is not operated and thus a current does not flow in the third resistor R3, so that the p-channel MOSFET M2 may not be operated. In this case, the source and the drain of the p-channel MOSFET M2 is not electrically connected to each other, and thus the resonance circuit 410 may not be connected to the charge circuit 440 and the super capacitor 450.

According to various embodiments, the charge circuit 440 may include at least one among a fifth capacitor C5, a third diode D3, and a fourth diode D4, and may rectify a resonance signal generated in the resonance circuit 410 into a direct current signal. According to various embodiments, when the super capacitor 450 is connected to the resonance circuit 410 by the switch circuit 430, the super capacitor 450 may be charged through a direct current signal rectified by the charge circuit 440. That is, as shown in FIG. 5, the super capacitor 450 may be charged during an interval in which the signal 509 output from the signal intensity detecting circuit 420 corresponds to the first level range (511). The super capacitor 450 may supply charged power to the active circuit 460. Accordingly, the pen 400 may provide an additional function provided by the active circuit 460, as well as an input function. According to various embodiments, the active circuit 460 is a circuit added to allow the pen 400 to provide another function in addition to an input function, and may include various circuits according to the demand of a user or the needs of a manufacturer. For example, the active circuit 460 may include a battery power level detecting sensor configured to detect the power level of the super capacitor 450 of the pen 400 and a communication module configured to provide the electronic device with information relating to the power level of the super capacitor 450 of the pen 400. In another example, the active circuit 460 may include a touch sensor or an acceleration sensor which are configured to determine whether the pen 400 is used by a user.

In the above description, each of elements (circuits) included in the pen 400 includes a particular device. However, according to various embodiments of the present disclosure, each of circuits included in the pen 400 may be configured by other devices performing the same functions.

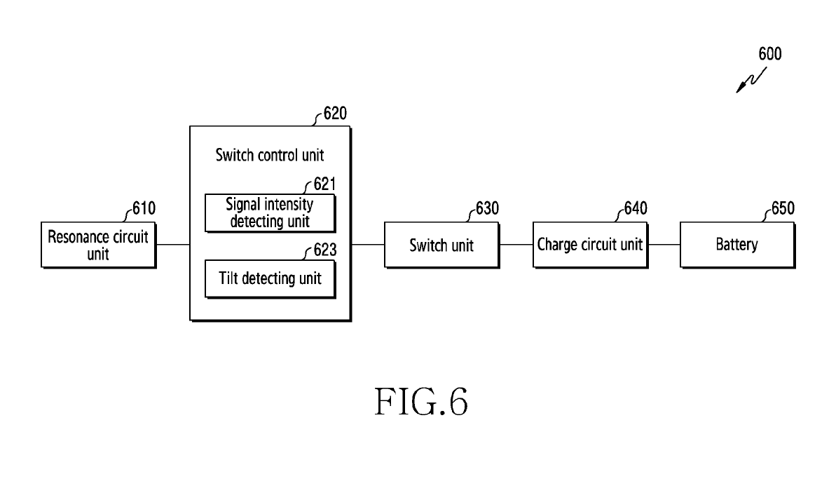

FIG. 6 illustrates another example of a block diagram of a pen according to various embodiments of the present disclosure. Hereinafter, a pen may include the entirety or a part of the pen 110 of FIG. 1.

Referring to FIG. 6, a pen 600 (e.g. the pen 110) may include at least one among a resonance circuit unit 610, a switch control unit 620, a switch unit 630, a charge circuit unit 640, and a battery (or a super capacitor) 650.

According to various embodiments, the resonance circuit unit 610 may generate a resonance signal by resonating with an electromagnetic field formed in a touch panel (e.g. the touch panel 123) of an electronic device. For example, when the pen 600 is in contact in the touch panel of the electronic device, the resonance circuit unit 610 may output a resonance signal by resonating with an electromagnetic field formed in at least one coil adjacent to a point which the pen 600 contacts among a plurality of coil included in the touch panel of the electronic device. The resonance signal may have an intensity gradually increasing during an interval in which an electromagnetic field is formed in the touch panel and gradually decreasing during an interval in which an electromagnetic field is not formed in the touch panel to receive a response signal (e.g. a resonance signal) of the pen 600. According to an embodiment, the resonance circuit unit 610 may further include a variable capacitor to detect the pen pressure of the pen 600. The electronic device may detect the pen pressure of the pen 600 through the change of a resonance frequency changing depending on the pen pressure of the pen 600.

According to various embodiments, the switch control unit 620 may output, to the switch unit 630, a control signal for connecting the resonance circuit unit 610 with the charge circuit unit 640 and the battery 650 on the basis of a resonance signal generated in the resonance circuit unit 610. The switch control unit 620 may include a signal intensity detecting unit 621 (e.g. the signal intensity detecting unit 220) that outputs a signal on the basis of the intensity of a resonance signal and a tilt detecting unit 623 that outputs a signal on the basis of the change of the intensity of a resonance signal. The signal intensity detecting unit 621 may output a signal corresponding to a second level range during an interval in which the intensity of a resonance signal is equal to or lower than an intensity Vth2 of a second reference range and may output a signal corresponding to a first level range higher than the second level range during an interval in which the intensity of a resonance signal exceeds the intensity of the second reference range, to allow the battery 650 to be charged within an interval in which the intensity of the resonance signal, which allows the pen 600 to perform an input function, is secured. The tilt detecting unit 623 may output a signal corresponding to the second level range during an interval in which the intensity of a resonance signal decreases and may output a signal corresponding to the first level range during an interval in which the intensity of a resonance signal increases, to allow the battery 650 to be charged during an interval in which the touch panel operates in a signal transmission interval. That is, the tilt detecting unit 623 may regard an interval in which the intensity of a resonance signal increases, as an interval in which the touch panel operates in a signal transmission interval and thus may output a signal corresponding to the first level range to the corresponding interval. The switch control unit 620 may generate a control signal by performing logical AND operation on a signal output from the signal intensity detecting unit 621 and a signal output from the tilt detecting unit 623, and may output the generated control signal to the switch unit 630. For example, the switch control unit 620 may output a control signal (e.g. a signal corresponding the first level range) that controls the switch unit 630 to allow the battery 650 to be charged only when the pen 600 contacts the touch panel of the electronic device, the intensity of a resonance signal exceeds the second reference intensity, and the intensity of a resonance signal increases (the touch panel operates in a signal transmission mode). For example, the switch control unit 620 may output a control signal (e.g. a signal corresponding the second level range) that controls the switch unit 630 to prevent the battery 650 from being charged when the pen 600 is not in contact the touch panel of the electronic device, the intensity of a resonance signal decreases in the state where the pen 600 is in contact with the touch panel (the touch panel operates in a signal reception mode), or the intensity of a resonance signal is equal to or less than the second reference intensity Vth2.

According to various embodiments, the switch unit 630 may connect the resonance circuit unit 610 with the charge circuit unit 640 and the battery 650 on the basis of a control signal output from the switch control unit 620. For example, when a signal corresponding to the first level range is received, the switch unit 630 may connect the resonance circuit unit 610 to the charge circuit unit 640 and the battery 650. In another example, when a signal corresponding to the second level range is received from the switch control unit 620, the switch unit 630 may block connection to prevent the resonance circuit unit 610 from being connected to the charge circuit unit 640 and the battery 650.

According to various embodiments, the charge circuit unit 640 may perform a function identical to or at least partially similar to that of the charge circuit unit 240 of FIG. 2. For example, the charge circuit unit 640 may rectify a resonance signal generated in the resonance circuit unit 610 by means of a diode and may provide a direct current signal to the battery 650. According to various embodiments, the battery 650 may be charged through a direct current signal rectified by the charge circuit unit 640.

According to various embodiments of the present disclosure, the pen 600 may further include an active circuit (not illustrated) configured to provide another function in addition to an input function. The active circuit may include, for example, a battery power level sensing sensor that senses the power level of the battery 650 and a communication module (e.g. near field communication module). The pen 600 may use the battery power level sensing sensor and the communication module to periodically provide the electronic device with information relating to the power level of the battery 650 or, only when the power level of the battery 650 is less than a reference power level, to provide the electronic device with a signal notifying that the battery 650 is required to be charged. For example, when information relating to a battery power level is received from the pen 600, the electronic device may determine whether the power level of the battery 650 is less than a reference power level, and when the power level of the battery 650 is less than a reference power level, may provide a user with information (e.g. visual information using a UI or an LED, haptic information including vibration, sound information including an alarm sound) for notifying that the battery 650 is required to be charged. In another example, when a signal notifying the battery 650 is required to be charged is received from the pen 600, the electronic device may provide a user with information for notifying that the pen 600 is required to be charged.

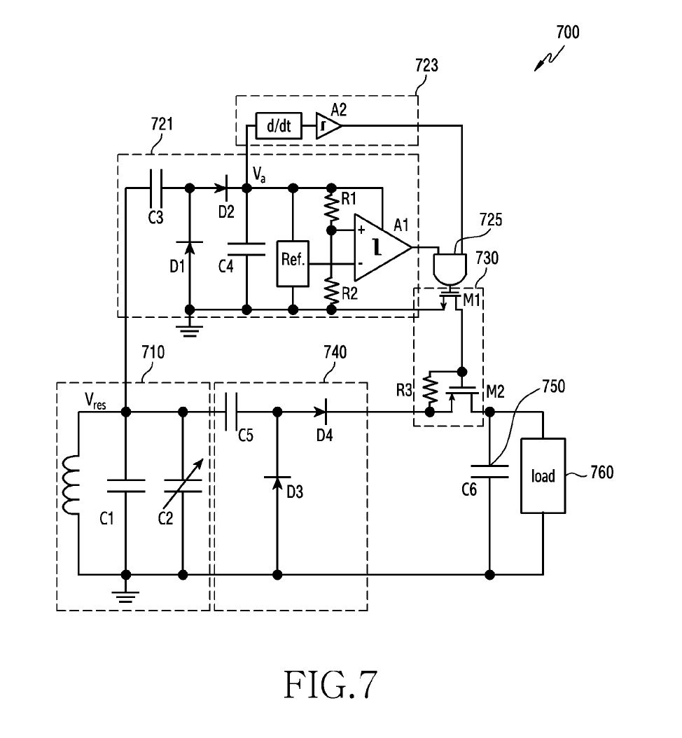

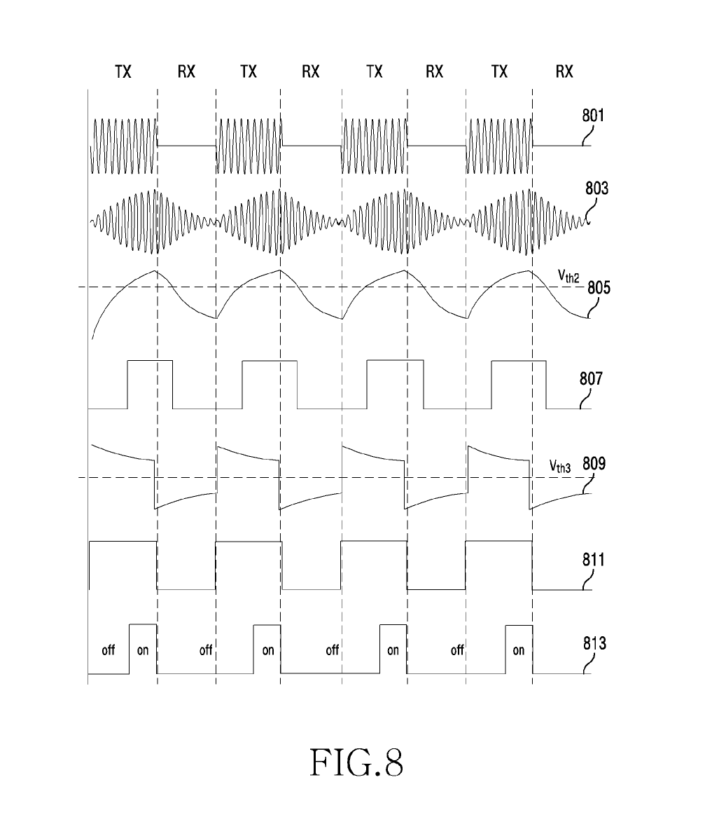

FIG. 7 illustrates another example of a circuit diagram of a pen according to various embodiments of the present disclosure. FIG. 8 illustrates another example of a signal output from each of elements of a pen according to various embodiments of the present disclosure. Hereinafter, a pen may include the entirety or a part of the pen 600 of FIG. 6.

Referring to FIG. 7, a pen 700 (e.g. the pen 110) may include at least one among a resonance circuit 710 (e.g. the resonance circuit unit 610), a signal intensity detecting circuit 721 (e.g. the signal intensity detecting unit 621), a tilt detecting circuit 723 (e.g. the tilt detecting unit 623), a logical AND circuit 725, a switch circuit 730 (e.g. the switch unit 630), a charge circuit 740 (e.g. the charge circuit unit 640), a super capacitor 750 (e.g. the battery 650), and an active circuit 760.

According to various embodiments, like the resonance circuit 410 of FIG. 4, the resonance circuit 710 may include at least one among an inductor L1, a capacitor C1, and a variable capacitor C2 and may generate a resonance signal by resonating with an electromagnetic field generated in at least one among a plurality of coils included in a touch panel of an electronic device (e.g. the electronic device 120). For example, the touch panel of the electronic device may periodically apply a signal (power) 801 to at least one coil among the plurality of coil, as shown in FIG. 8, so as to form an electromagnetic field in a signal transmission interval (TX interval) and receive a response signal of the pen 700 during an signal reception interval (RX interval). When an electromagnetic field is formed in the touch panel of the electronic device, the resonance circuit 710 may generate a resonance signal by resonating with the electromagnetic field formed in the touch panel. For example, the resonance circuit 701 may output a resonance signal 803 that has an intensity gradually increasing during an interval (e.g. signal transmission interval) in which power is applied to the touch panel of the electronic device and gradually decreasing during an interval (e.g. signal reception interval) in which power is not applied to the touch panel of the electronic device, as shown in FIG. 8.

According to various embodiments, the signal intensity detecting circuit 721 may receive a resonance signal output from the resonance circuit 710 and may include at least one among a third capacitor C3, a fourth capacitor C4, a first diode D1, a second diode D2, a reference voltage generating element Ref, a first resistor R1, a second resistor R2, and a OP amp A1. The signal intensity detecting circuit 721 may compare a voltage applied to the second resistor R2 with the voltage of a second reference voltage element Ref to output a signal, like the signal intensity detecting circuit 420 of FIG. 4. For example, when the resonance signal 803 is generated in the resonance circuit 710, a voltage 805 may be applied to the second resistor R2, as shown in FIG. 8. When the voltage 805 applied to the second resistor R2 is equal to or less than the voltage Vth2 of the second reference voltage element Ref, the op amp A1 may output a signal 807 corresponding to a second level range to the logical AND circuit 725. In another example, when the voltage 805 applied to the second resistor R2 exceeds the voltage Vth2 of the second reference voltage element Ref, the op amp A1 may output a signal 807 corresponding to a first level range higher than the second level range to the logical AND circuit 725.

According to various embodiments, the tilt detecting circuit 723 may be connected to the signal intensity detecting circuit 721 and may include at least one of a differential circuit d/dt and an op amp A2. The differential circuit d/dt may output a signal 809 representing the change of the voltage of a fourth capacitor C4, and the op amp A2 may convert the signal 809 representing the change of the voltage of the fourth capacitor C4 into a pulse signal 811 and then output the converted signal 811 to the logical AND circuit 725, as shown FIG. 8.

According to various embodiments, the logical AND circuit 725 may perform logical AND operation on a signal output from the signal intensity detecting circuit 721 and a signal output from the tilt detecting circuit 723 and then output the result therefrom to the switch circuit 730. For example, when the signal intensity detecting circuit 721 and the tilt detecting circuit 723 output a signal corresponding to the first level range, the logical AND circuit 725 may output a signal 813 corresponding to the first level range, as shown in FIG. 8. In another example, when one circuit among the signal intensity detecting circuit 721 and the tilt detecting circuit 723 output a signal corresponding to the second level range, the logical AND circuit 725 may output a signal 813 corresponding to the second level range to the switch circuit 730, as shown in FIG. 8.

According to various embodiments, the switch circuit 730 may receive a signal output from the logical AND circuit 725 and may include at least one among an n-channel MOSFET M1, a third resistor R3, and a p-channel MOSFET M2. The n-channel MOSFET M1 may operate in the case where a signal corresponding to the first level range is output from the logical AND circuit 725. When the n-channel MOSFET M1 operates, a current flows in the third resistor R3 and thus a voltage is applied thereto. Accordingly, the p-channel MOSFET M2 may operate. When the p-channel MOSFET M2 operates, a source and a drain of the p-channel MOSFET M2 are electrically connected to each other, and thus the resonance circuit 710 may be connected to the charge circuit 740 and the super capacitor 750. That is, the switch circuit 730 may connect the resonance circuit 710 with the charge circuit 740 and the super capacitor 750 during an interval (on interval) in which a signal 813 received from the logical AND circuit 725 corresponds to a first level, and may block the connection to prevent the resonance circuit 710 from being connected to the charge circuit 740 and the super capacitor 750 during an interval (off interval) in which a received signal 813 corresponds to a second level, as shown in FIG. 8.

According to various embodiments, the charge circuit 740 may include at least one among a fifth capacitor C5, a third diode D3, and a fourth diode D4, and like the charge circuit 440 as shown in FIG. 4, may rectify an alternating current voltage generated in the resonance circuit 710 and then provide the rectified voltage to the super capacitor 750 to charge the super capacitor 750. According to various embodiments, the super capacitor 750 may supply power to the active circuit 760, and the active circuit 760 may include circuits configured to provide various functions in addition to an input function. For example, the active circuit 760 may include a battery power level sensing circuit and a communication module. The active circuit 760 may periodically transmit information relating to the power level of the super capacitor 750 to the electronic device, or when the power lever of the super capacitor 750 is equal to or less than a reference battery power level, may transmit, to the electronic device, a signal notifying that the pen 700 is required to be charged. On the basis of the received information, the electronic device may provide a user with information for notifying that the pen 700 is required to be charged.

In the above description, each of elements (circuits) included in the pen 700 includes a particular device. However, according to various embodiments of the present disclosure, each of elements included in the pen 700 may be configured by other devices performing the same functions.

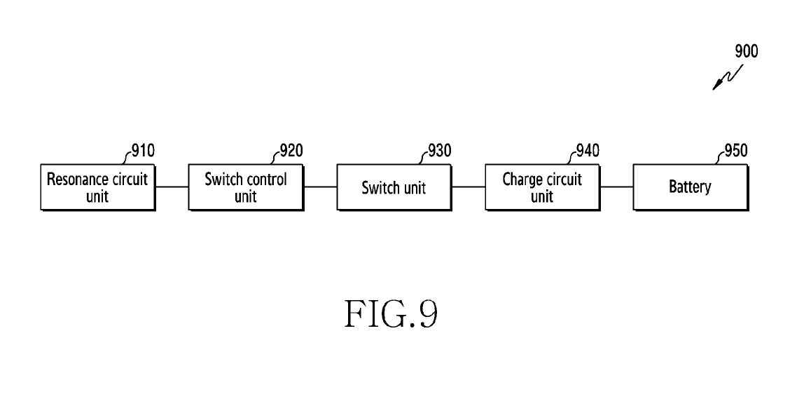

FIG. 9 illustrates yet another example of a block diagram of a pen according to various embodiments of the present disclosure. Hereinafter, a pen may include the entirety or a part of the pen 110 of FIG. 1.

Referring to FIG. 9, a pen 900 (e.g. the pen 110) may include at least one among a resonance circuit unit 910, a switch control unit 920, a switch unit 930, a charge circuit unit 940, and a battery 950.

According to various embodiments, the resonance circuit unit 910 may generate a resonance signal by resonating with an electromagnetic field formed in an electronic device (e.g. the electronic device 120). For example, like the resonance circuit unit 210 of FIG. 2, when the pen 900 is housed in a housing space (e.g. the housing space 125) of an electronic device, the resonance circuit unit 910 may output a resonance signal by resonating with an electromagnetic field formed in a detecting sensor (e.g. the detecting sensor 121) disposed in the housing space. In another example, like the resonance circuit unit 210 of FIG. 2, when the pen 900 is in contact with a touch panel (e.g. the touch panel 123) of the electronic device, the resonance circuit unit 910 may generate a resonance signal by resonating with an electromagnetic field formed in the touch panel of the electronic device.

According to various embodiments, the switch control unit 920 may output a control signal to the switch unit 930 on the basis of the intensity of a resonance signal generated in the resonance circuit unit 910. For example, when the intensity of a resonance signal generated in the resonance circuit unit 910 is greater than an intensity Vth1 of a first reference range, the switch control unit 920 may output a control signal (a signal corresponding to a first level range) that controls the switch unit 930 to allow the battery 950 to be charged. When the intensity of a resonance signal is less than the intensity Vth1 of the first reference range and greater than an intensity Vth2 of a second reference range, the switch control unit 920 may output a control signal configured to control the switch unit 930 to charge the battery 950 during an interval, in which the intensity of the resonance signal increases, so as to allow the battery 950 to be charged only during an signal transmission interval (TX interval) of the touch panel. Meanwhile, the switch control unit 920 may output a control signal (e.g. a signal corresponding to the second level range) that controls the switch unit 930 to prevent the battery 950 from being charged during an interval in which the intensity of a resonance signal decreases or an interval in which the intensity of a resonance signal is equal to or less than the intensity of the second reference range. That is, the switch control unit 920 may output a control signal that controls the switch unit 930 to allow the battery 950 to be charged only during a time interval in which the touch panel of the electronic device operates in an signal transmission mode in the state where the pen 900 is in contact with the touch panel of the electronic device, or during a time interval in which the pen 900 is housed in the housing space of the electronic device.

According to various embodiments, the switch unit 930 may connect the resonance circuit unit 910 with the charge circuit unit 940 and the battery 950 on the basis of an output signal of the switch control unit 920. For example, when a signal corresponding to the first level range is received from the switch control unit 920, the switch unit 930 may connect the resonance circuit unit 910 to the charge circuit unit 940 and the battery 950. In another example, when a signal corresponding to the second level range is received from the switch control unit 920, the switch unit 930 may block connection to prevent the resonance circuit unit 910 from being connected to the charge circuit unit 940 and the battery 950.

According to various embodiments, the charge circuit unit 940 may perform a function identical to or at least partially similar to that of the charge circuit unit 240 of FIG. 2. For example, when the charge circuit unit 940 is connected to the resonance circuit unit 910, the charge circuit unit 940 may rectify a resonance signal generated in the resonance circuit unit 910 and then provide the rectified signal to the battery 950 to charge the battery 950.

According to various embodiments of the present disclosure, the pen 900 may further include an active circuit configured to provide another function in addition to an input function. For example, the pen 900 may further include an active circuit that provides a function for periodically providing the electronic device with information of the battery 950, determining whether the pen 900 is being used, or determining whether the pen 900 is lost. When the pen 900 includes an active circuit, the pen 900 may supply power to the active circuit by using the battery 950.

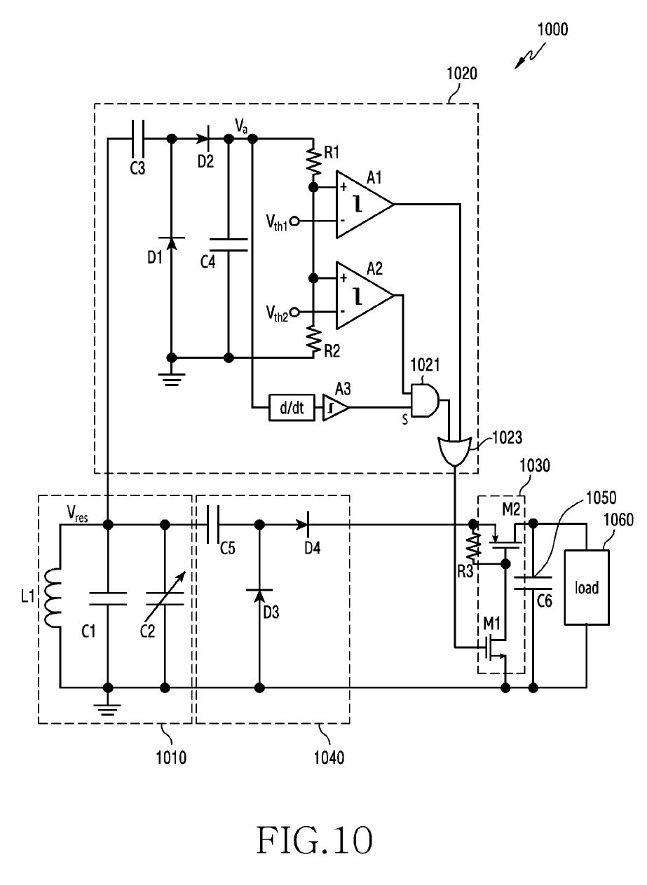

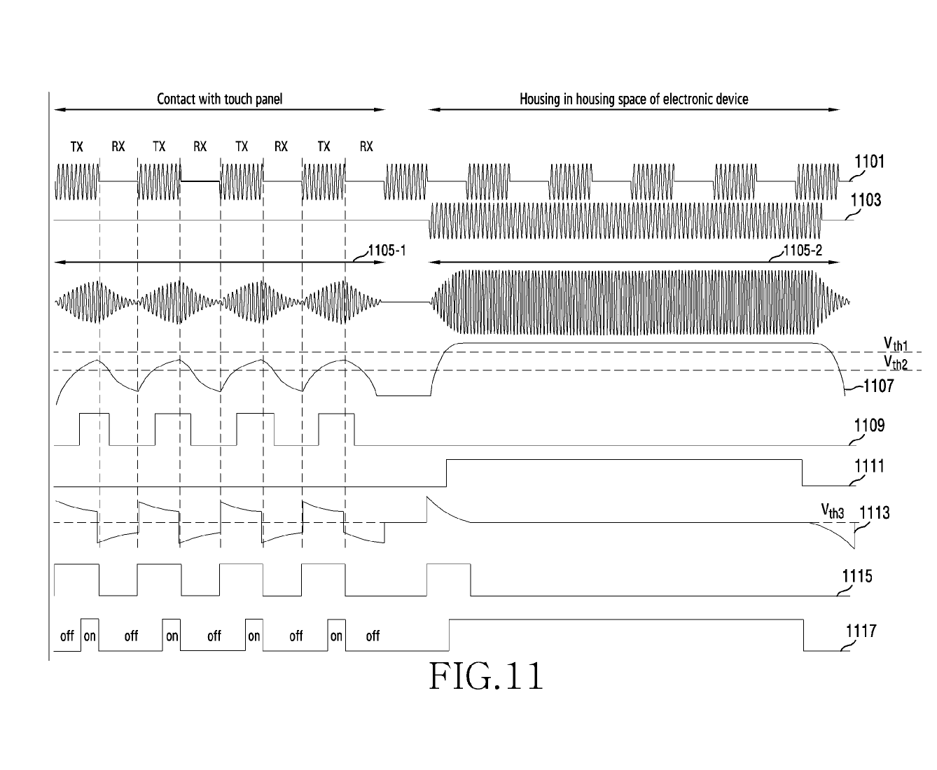

FIG. 10 illustrates yet another example of a circuit diagram of a pen according to various embodiments of the present disclosure. FIG. 11 illustrates yet another example of a signal output from each of elements of a pen according to various embodiments of the present disclosure. Hereinafter, a pen may include the entirety or a part of the pen 900 of FIG. 9.

Referring to FIG. 10, a pen 1000 (e.g. the pen 110) may include at least one among a resonance circuit 1010 (e.g. the resonance circuit unit 910), a switch control circuit 1020 (e.g. the switch control unit 920), a switch circuit 1030 (e.g. the switch unit 930), a charge circuit 1040 (e.g. the charge circuit unit 940), a super capacitor 1050 (e.g. the battery 950), and an active circuit 1060.

According to various embodiments, the resonance circuit 1010 may include at least one among an inductor L1, a first capacitor C1, and a second capacitor (variable capacitor) C2, and may output a resonance signal by resonating with an electromagnetic field formed in an electronic device (e.g. the electronic device 120). For example, a touch panel (e.g. the touch panel 123 of FIG. 1) of the electronic device may include a plurality of coils. As shown in FIG. 11, a signal 1101 may be applied to at least one coil among the plurality of coils to periodically form an electromagnetic field. When the pen 1000 contacts the touch panel of the electronic device, the resonance circuit 1010 may output a first resonance signal 1105-1 by resonating with an electromagnetic field formed in the touch panel of the electronic device. In another example, a detecting sensor included in a housing space of the electronic device may include at least one coil configured to detect that the pen 1000 is housed, and a signal 1103 may be applied to the at least one coil to periodically form an electromagnetic field, as shown in FIG. 11. When the pen 1000 is housed in the housing space of the of the electronic device, the resonance circuit 1010 may output a second resonance signal 1105-2 by resonating with an electromagnetic field formed in the at least one coil included in the detecting sensor.

According to various embodiments, the switch control circuit 1020 may include at least one among a third capacitor C3, a fourth capacitor C4, a first diode D1, a second diode D2, a first reference voltage element (not illustrated), a second reference voltage element (not illustrated), a first resistor R1, a second resistor R2, a first op amp A1, a second op amp A2, a third op amp A3, a logical AND circuit 1021, and a logical OR circuit 1023, and may receive a resonance signal from the resonance circuit 1010. The third capacitor C3, the first diode D1, and the second diode D2 may rectify a resonance signal generated in the resonance circuit 1010 into a direct current signal. The fourth capacitor C4 may be charged by the rectified direct current signal. A voltage may be applied to the first resistor R1 and the second resistor R2 by the rectified direct current signal and the fourth capacitor C4. As shown in FIG. 11, when a voltage 1107 applied to the second resistor R2 exceeds the voltage Vth1 of the first reference voltage element, the first op amp A1 may output a signal 1111 corresponding to a first level range to the logical OR circuit 1023. When the voltage applied to the second resistor R2 is equal to or less than the voltage Vth1 of the first reference voltage element, the first op amp A1 may output a signal 1111 corresponding to a second level range to the logical OR circuit 1023. When a voltage 1107 applied to the second resistor R2 exceeds the voltage Vth2 of the second reference voltage element, the second op amp A2 may output a signal corresponding to the first level range to the logical AND circuit 1021. When the voltage applied to the second resistor R2 is equal to or less than the voltage Vth2 of the second reference voltage element, the second op amp A2 may output a signal 1109 corresponding to the second level range to the logical AND circuit 1021. A differential circuit d/dt may output a signal 1113 representing the change of the voltage of the fourth capacitor C4 to the third op amp A3. The third op amp A3 may convert the signal 1113 representing the change of the voltage of the fourth capacitor C4 into a pulse signal 1115 and then output the converted signal 1115 to the logical AND circuit 1021. When both of a signal 1109 received from the second op amp A2 and a signal 1115 received from the third op amp A3 belong to the first level range, the logical AND circuit 1021 may output a signal corresponding to the first level range to the logical OR circuit 1023. When one among a signal 1109 received from the second op amp A2 and a signal 1115 received from the third op amp A3 belong to the second level range, the logical AND circuit 1021 may output a signal corresponding to the second level range to the logical OR circuit 1023. When a signal received from one among the first op amp A1 and the logical AND circuit 1021 belongs to the first level range, the logical OR circuit 1023 may output a signal 1117 corresponding to the first level range to the switch circuit 1030. When a signal received from the first op amp A1 and the logical AND circuit 1021 belongs to the second level range, the logical OR circuit 1023 may output a signal 1117 corresponding to the second level range to the switch circuit 1030.

According to various embodiments, the switch circuit 1030 may receive a signal output from the logical OR circuit 1023 and may include at least one among an n-channel MOSFET M1, a third resistor R3, and a p-channel MOSFET M2. The n-channel MOSFET M1 may operate when a signal corresponding to the first level range is received from the logical OR circuit 1023, and when the n-channel MOSFET M1 operates, a voltage may be applied to the third resistor R3. The p-channel MOSFET M2 may operate when a voltage is applied to the third resistor R3, and thus a source and a drain of the p-channel MOSFET M2 are electrically connected to each other so that the resonance circuit 1010 may be connected to the charge circuit 1040 and the super capacitor 1050.

According to various embodiments, the charge circuit 1040 may include at least one among a fifth capacitor C5, a third diode D3, and a fourth diode D4, and may rectify a resonance signal generated in the resonance circuit 1010 into a direct current signal and then provide the rectified signal to the super capacitor 1050, like the charge circuit 440 as shown in FIG. 4. According to various embodiments, the super capacitor 1050 may supply power to the active circuit 1060 to drive the active circuit 1060. Accordingly, the pen 1100 may provide a user with an additional function provided from the active circuit 1060. For example, the pen 1100 may use the active circuit 1060 to provide the electronic device with information relating to the charge state of the super capacitor 1050, thereby providing a user with the battery state of the pen 1100.

In the above description, each of elements (circuits) included in the pen 1100 includes a particular device. However, according to various embodiments of the present disclosure, each of circuits included in the pen 1100 may be configured by other devices performing the same functions.

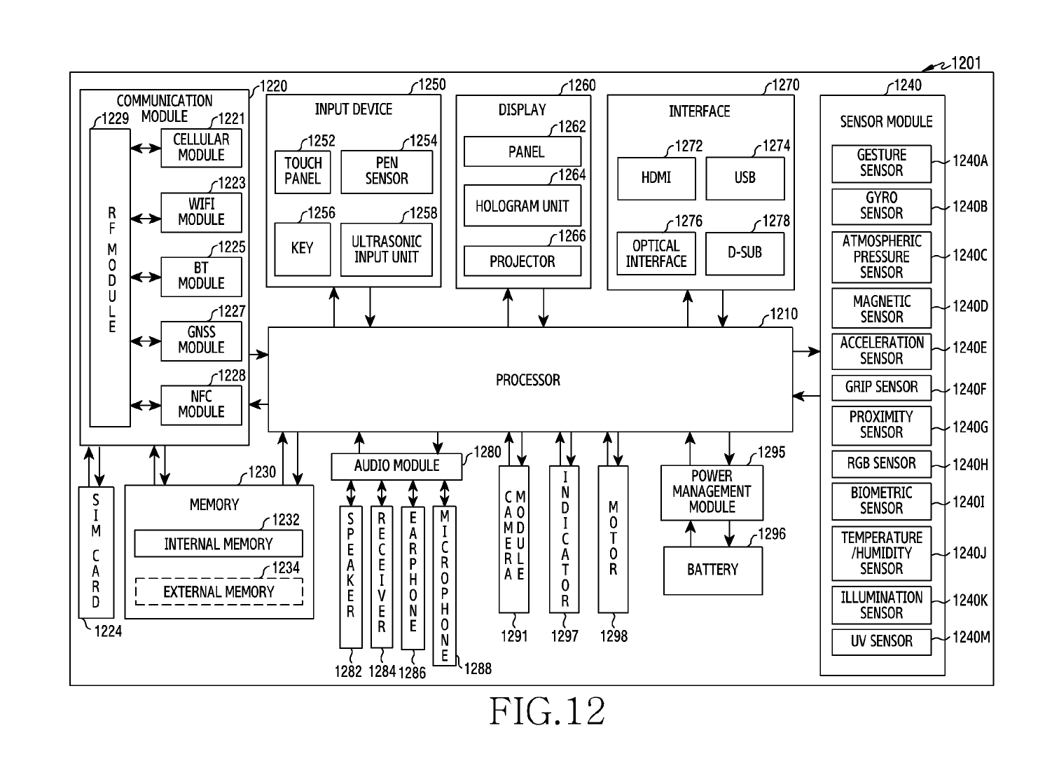

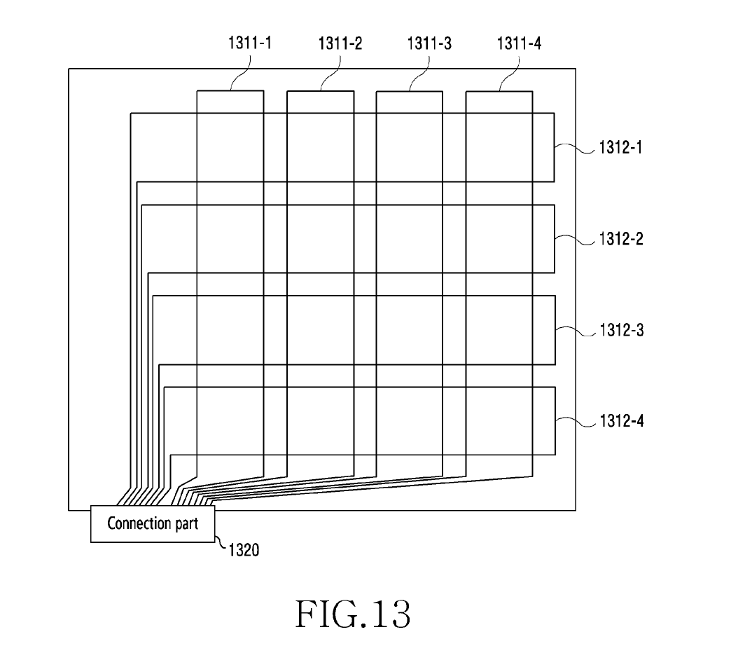

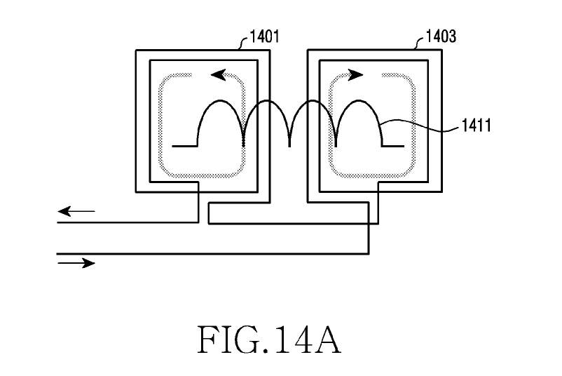

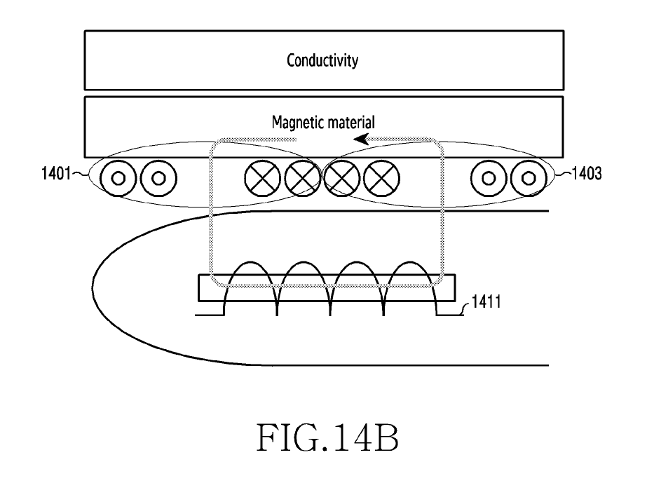

FIG. 12 illustrates a block diagram of an electronic device according to various embodiments of the present disclosure. FIG. 13 illustrates a specific configuration of a pen sensor according to various embodiments of the present disclosure. FIGS. 14A and 14B illustrate a specific configuration of a detecting sensor according to various embodiments of the present disclosure. In the following description, an electronic device may include the entirety or a part of the electronic device 120 illustrated in FIG. 1. Hereinafter, a pen may include the entirety or a part of the pen 110 of FIG. 1.

Referring to FIG. 12, an electronic device 1201 (e.g. the electronic device 120) may include at least one among at least one processor (e.g. AP) 1210, a communication module 1220, a subscriber identification module 1224, a memory 1230, a sensor module 1240, a input device 1250, a display 1260, an interface 1270, an audio module 1280, a camera module 1291, a power management module 1295, a battery 1296, an indicator 1297, and a motor 1298.

The processor 1210 may drive, for example, an operating system or application programs to control a plurality of hardware or software elements connected to the processor 1210 and may perform various types of data processing and operations. The processor 1210 may be implemented by, for example, a System on Chip (SoC). According to an embodiment, the processor 1210 may further include a Graphic Processing Unit (GPU) and/or an image signal processor. The processor 1210 may also include at least some of the elements illustrated in FIG. 12 (e.g. a cellular module 1221). The processor 1210 may load, in volatile memory, commands or data received from at least one of the other elements (for example, non-volatile memory), process the loaded commands or data, and store the resultant data in the non-volatile memory.

According to various embodiments, the processor 1210 may determine whether the pen (e.g. the pen 110) contacts a touch panel 1252 of the electronic device 1201. For example, the processor 1210 may form an electromagnetic field by applying a signal to at least one coil among the plurality of coils included in the touch panel 1252 during a signal transmission interval (e.g. TX interval), and may receive a response signal of the pen during a signal reception interval (e.g. RX interval), thereby determining whether the pen contacts the touch panel 1252.

According to various embodiments, when the movement of the pen is not detected during a specified time interval in the state where the pen is in contact with the touch panel 1252 of the electronic device 1201, the processor 1210 may convert the operation mode of the electronic device 1201 into a charging mode. For example, when the movement of the pen is not detected during a time interval configured by a user in the state where the pen is in contact with the touch panel 1252, the processor 1210 may convert the operation mode of the electronic device 1201 into a charging mode of increasing a period in which a signal is applied to a coil corresponding to a point which the pen contacts, or increasing the size of a signal applied to a coil corresponding to a point which the pen contacts. When a specified time interval has passed after the electronic device 1201 starts operating in the charging mode, it is identified that the battery power level of the pen is equal to or greater than a reference power level through the battery information of the pen received through the communication module 1220, or the movement of the pen is detected, the processor 1210 may convert the operation mode of the electronic device 1201 into a normal mode.

According to various embodiments, the processor 1210 may control to display 1260 to display a User Interface (UI) representing that the battery of the pen is required to be charged on the basis of the battery information of the pen. For example, the processor 1210 may periodically receive the battery information of the pen through the communication module 1220. The processor 1210 may determine whether the battery power level of the pen is equal to or less than a first reference battery power level on the basis of the received battery information. When the battery power level of the pen is equal to or less than the first reference battery power level, the processor 1210 may control the display 1260 to display a UI representing that the battery of the pen is required to be charged. According to an embodiment, when the touch panel 1252 includes a separate coil for charging, the processor 1210 may control the display 1260 to display, on the position of the corresponding coil, a UI representing that the battery of the pen is required to be charged and may charge the pen by applying a signal to the corresponding coil. When a pre-defined time interval has passed, or the battery of the pen is charged to a predetermined level or greater (the battery power level of the pen is equal to or greater than a second reference battery power level), the processor 1210 may control the display 1260 to remove the UI representing that the battery of the pen is required to be charged, and may block a signal applied to a charging coil.

The communication module 1220 may include, for example, the cellular module 1221, a Wi-Fi module 1223, a Bluetooth module 1225, a GNSS module 1227, an NFC module 1228, and an RF module 1229. The cellular module 1221 may provide, for example, a voice call, a video call, a text message service, an Internet service, or the like through a communication network. According to an embodiment, the cellular module 1221 may identify or authenticate the electronic device 1201 in the communication network using a subscriber identification module (for example, a Subscriber Identification Module (SIM) card) 1224. According to an embodiment, the cellular module 1221 may perform at least some of the functions that the processor 1210 may provide. According to an embodiment, the cellular module 1221 may include a communication processor (CP). In some embodiments, at least some (e.g. two or more) of the cellular module 1221, the Wi-Fi module 1223, the Bluetooth module 1225, the GNSS module 1227, and the NFC module 1228 may be included in a single Integrated Chip (IC) or IC package. The RF module 1229 may transmit/receive, for example, a communication signal (for example, an RF signal). The RF module 1229 may include, for example, a transceiver, a Power Amp Module (PAM), a frequency filter, a Low Noise Amplifier (LNA), an antenna, or the like. According to another embodiment, at least one of the cellular module 1221, the Wi-Fi module 1223, the Bluetooth module 1225, the GNSS module 1227, and the NFC module 1228 may transmit/receive an RF signal through a separate RF module. The subscriber identification module 1224 may include, for example, an embedded SIM or a card including a subscriber identification module and may contain unique identification information (for example, an Integrated Circuit Card Identifier (ICCID)) or subscriber information (for example, International Mobile Subscriber Identity (IMSI)).

The memory 1230 may include, for example, an internal memory 1232 or an external memory 1234. The internal memory 1232 may include, for example, at least one of a volatile memory (for example, a DRAM, an SRAM, an SDRAM, or the like) and a non-volatile memory (for example, a One Time Programmable ROM (OTPROM), a PROM, an EPROM, an EEPROM, a mask ROM, a flash ROM, a flash memory, a hard disc drive, or a Solid State Drive (SSD)). The external memory 1234 may include a flash drive, for example, a Compact Flash (CF), a Secure Digital (SD), a Micro-SD, a Mini-SD, an extreme Digital (xD), a Multi-Media Card (MMC), a memory stick, and the like. The external memory 1234 may be functionally or physically connected to the electronic device 1201 through various interfaces.

The sensor module 1240 may, for example, measure a physical quantity or detect the operating state of the electronic device 1201 and may convert the measured or detected information into an electrical signal. The sensor module 1240 may include, for example, at least one of a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (for example, a Red, Green, and Blue (RGB) sensor), a biometric sensor 1240I, a temperature/humidity sensor 1240I, an illumination sensor 1240K, and a ultraviolet (UV) sensor 1240M. Additionally or alternatively, the sensor module 1240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1240 may further include a control circuit configured to control one or more sensors included therein. In some embodiments, the electronic device 1201 may further include a processor, which is configured to control the sensor module 1240, as a part of the processor 1210 or separately from the processor 1210 in order to control the sensor module 1240 while the processor 1210 is in a sleep state.

The input device 1250 may include, for example, the touch panel 1252, a (digital) pen sensor 1254, a key 1256, or an ultrasonic input device 1258. The touch panel 1252 may use, for example, at least one of a capacitive type, a resistive type, an infrared type, and an ultrasonic type. Furthermore, the touch panel 1252 may further include a control circuit. The touch panel 1252 may further include a tactile layer to provide a user with a tactile reaction. The (digital) pen sensor 1254 may include, for example, a recognition sheet as a part of the touch panel 1251 or separately from the touch panel 1252. For example, as shown in FIG. 13, the (digital) pen sensor 1254 may include: a first coil group 1311-1, 1311-2, 1311-3, 1311-4 disposed in a first direction; a second coil group 1312-1, 1312-2, 1312-3, 1312-4 disposed in a second direction perpendicular to the first direction; and a connection part 1320 that connects the first coil group and the second coil group. The (digital) pen sensor 1254 may apply power at least one coil among the plurality of coils included in the first coil group and the second coil group during a signal transmission period and receive a response signal of the pen from the at least one coil among the plurality of coils included in the first coil group and the second coil group during a signal reception period, thereby identifying the coordinates of a point that the pen contacts. The key 1256 may include, for example, a physical button, an optical key, or a keypad. The ultrasonic input device 1258 may detect ultrasonic waves, which are generated by an input tool, through a microphone (for example, a microphone 1288) to identify data corresponding to the detected ultrasonic waves.

The display 1260 may include a panel 1262, a hologram device 1264, a projector 1266 and/or a control circuit configured to control the same. The panel 1262 may be implemented to be, for example, flexible, transparent, or wearable. The panel 1262, together with the touch panel 1252, may be configured as one or more modules. The hologram device 1264 may show a three dimensional image in the air by using an interference of light. The projector 1266 may display an image by projecting light onto a screen. The screen may be located, for example, in the interior of, or on the exterior of, the electronic device 1201. The interface 1270 may include, for example, an HDMI 1272, a USB 1274, an optical interface 1276, or a D-subminiature (D-sub) 1278. Additionally or alternatively, the interface 1270 may, for example, include a Mobile High-definition Link (MHL) interface, a Secure Digital (SD) card/Multi-Media Card (MMC) interface, or an Infrared Data Association (IrDA) standard interface.

The audio module 1280 may convert, for example, sound into an electrical signal, and vice versa. The audio module 1280 may process sound information that is input or output through, for example, a speaker 1282, a receiver 1284, earphones 1286, the microphone 1288, and the like. The camera module 1291 is, for example, a device that can photograph a still image and a moving image. According to an embodiment, the camera module 1291 may include one or more image sensors (for example, a front sensor or a rear sensor), a lens, an image signal processor (ISP), or a flash (for example, an LED or xenon lamp). The power management module 1295 may manage, for example, the power of the electronic device 1201. According to an embodiment, the power management module 1295 may include a Power Management Integrated Circuit (PMIC), a charger IC, or a battery or fuel gauge. The PMIC may use a wired and/or wireless charging method. Examples of the wireless charging method may include a magnetic resonance method, a magnetic induction method, an electromagnetic wave method, or the like. Additional circuits (for example, a coil loop, a resonance circuit, a rectifier, and the like) for wireless charging may be further included. A battery gauge may measure, for example, the power level of the battery 1296 and a voltage, current, or temperature while charging. The battery 1296 may include, for example, a rechargeable battery and/or a solar battery.

The indicator 1297 may display a particular state, for example, a booting state, a message state, a charging state, or the like of the electronic device 1201 or a part (for example, the processor 1210) of the electronic device 1201. The motor 1298 may convert an electrical signal into a mechanical vibration and may generate a vibration, a haptic effect, or the like. The electronic device 1201 may include a mobile TV support device (for example, GPU) that may process media data according to a standard, such as Digital Multimedia Broadcasting (DMB), Digital Video Broadcasting (DVB), mediaFlo™, and the like. Each of the elements described in the present disclosure may be configured by one or more components, and the names of the corresponding elements may vary based on the type of an electronic device. According to various embodiments, an electronic device (for example, the electronic device 1201) may not include some elements, or may further include additional elements. Some elements may be coupled to constitute one object, but the electronic device may perform the same functions as those of the corresponding elements before being coupled to each other.

According to various embodiments of the present disclosure, the electronic device 1201 may further include a detecting sensor (not illustrated) configured to detect that the pen is housed in a housing space of the electronic device. According to various embodiments, the detecting sensor may include at least one coil in order to provide a function of charging the battery of the pen, in addition to the function of determining whether the pen is housed in the housing space. For example, as shown in FIG. 14A, the detecting sensor may include a first coil 1401 wound in a first direction and a second coil 1403 wound in a second direction opposite to the first direction, and as shown in FIG. 14B, a magnetic material (e.g. paramagnetic material) and a conductor may be attached to the first coil 1401 and the second coil 1403 in order to reduce electromagnetic field leaking to the periphery. When the pen is housed in the housing space, the first coil 1401 and the second coil 1403 of the detecting sensor may be disposed at a location adjacent to an inductor 1411 included in the resonance circuit of the pen. The detecting sensor may periodically apply a signal (power) to the first coil 1401 and the second coil 1403 to form an electromagnetic field, thereby charging the battery of the pen. For example, when the detecting sensor periodically applies a signal to the first coil 1401 and the second coil 1403 to form an electromagnetic field and receives a response signal (e.g. resonance signal) from the pen, the detecting sensor may efficiently charge the battery of the pen by increasing a time interval during which the signal is applied to the first coil 1401 and the second coil 1403, shortening a cycle by which the signal is applied, or changing the intensity of the signal applied to the coil into a further greater intensity.

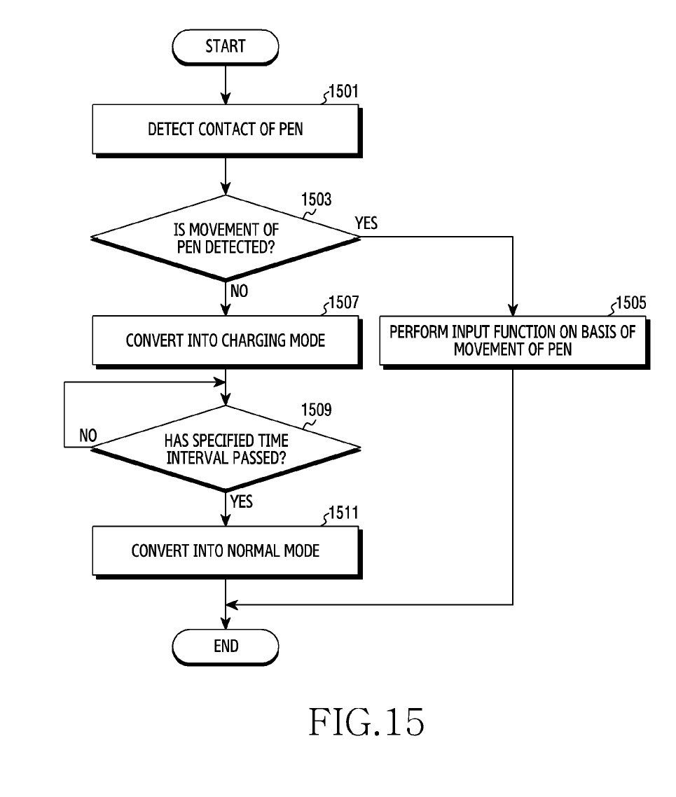

FIG. 15 illustrates an example of a flowchart of charging a battery of a pen in an electronic device according to various embodiments of the present disclosure. In the following description, an electronic device may include the entirety or a part of the electronic device 1201 illustrated in FIG. 12. A pen may include the entirety or a part of the pen 200 of FIG. 2, the pen 600 of the FIG. 6, or the pen 900 of FIG. 9.

Referring to FIG. 15, the electronic device may detect a contact of a pen (e.g. the pen 110) on a touch panel of the electronic device, in operation 1501. For example, the processor 1210 of the electronic device 1201 may form an electromagnetic field by applying a signal (power) to at least one coil among a plurality of coils included in the touch panel 1252 during a signal transmission interval. When a response signal of the pen is received from at least one coil among the plurality of coils included in the touch panel 1252 during a signal reception interval, the processor 1210 may determine that the pen is in contact with the touch panel 1252.

According to various embodiments, the electronic device may determine whether the movement of the pen is detected during a specified time interval, in operation 1503. For example, the processor 1210 may determine whether the pen is moved to perform an input function, in the state where the pen is in contact with the touch panel 1252. For example, the processor 1210 may apply a signal to at least one coil among the plurality of coils included in the touch panel 1252 during a signal transmission interval, and may receive a response signal of the pen from at least one coil among the plurality of coils during a signal reception interval. The processor 1210 may identify the coordinates of a point which the pen contacts on the basis of a response signal received from at least one coil. When the coordinates of the point which the pen contacts are changed during the specified time interval, the processor 1210 may determine that the movement of the pen is detected.

According to various embodiments, when the electronic device has detected the movement of the pen in operation 1503, the electronic device may perform an input function on the basis of the movement of the pen, in operation 1505. For example, the processor 1210 may perform a function (e.g. inputting a text, executing an application) mapped on coordinates changing depending on the movement of the pen.

According to various embodiments, when the movement of the pen is not detected in operation 1503, the electronic device may convert the operation mode of the electronic device to a charging mode, in operation 1507. For example, the processor 1210 may increase a time interval in which a signal is applied to at least one coil corresponding to a point that the pen contacts among the plurality of coils included in the touch panel 1252, or strengthening the intensity of the applied signal.

According to various embodiments, the electronic device may determine whether a specified time interval has passed, in operation 1509. For example, the processor 1210 may determine whether a time interval (e.g. one minute) configured by a user has passed after the operation mode of the electronic device 1201 is converted into a charging mode. When the specified time interval has not passed, the processor 1210 may continuously determine whether the specified time interval has passed.

According to various embodiments, when it is determined that a specified time interval has passed, in operation 1509, the electronic device may convert the operation mode of the electronic device to a normal mode, in operation 1511. For example, the processor 1210 may restore a time interval in which a signal is applied to at least one coil corresponding to a point which the pen contacts or the intensity of the signal, to a time interval or an intensity before the operation of the charging mode.

In the above description, it has been explained that when a specified time interval has passed after the operation mode of the electronic device is converted to a charging mode, the electronic device converts the operation mode of the electronic device into a normal mode. However, according to various embodiments of the present disclosure, the electronic device may convert the operation mode of the electronic device into a normal mode at a time point at which the movement of the pen is detected during the charging mode. For example, the processor 1210 may determine whether the pen is moved on the basis of a response signal of the pen received through the touch panel 1252 while the electronic device 1201 operates in a charging mode. When the pen is moved, the processor 1210 may convert the operation mode of the electronic device into a normal mode and then perform an input function on the basis of the movement of the pen.

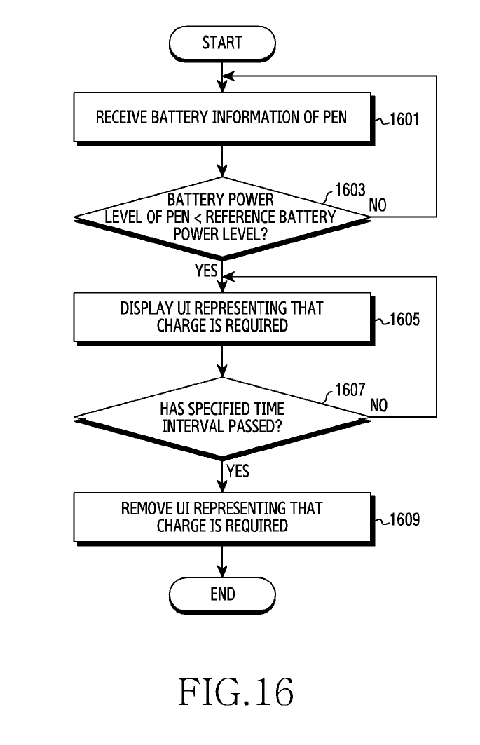

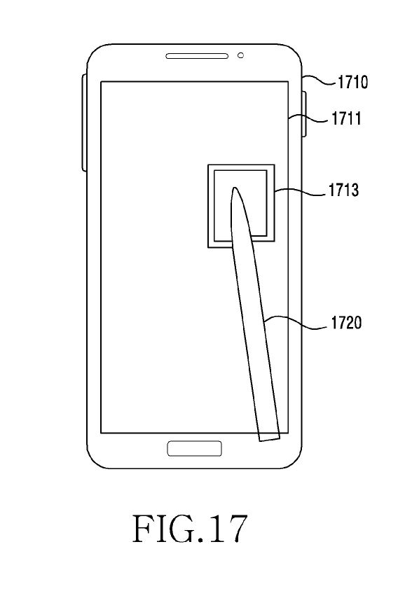

FIG. 16 illustrates another example of a flowchart of charging a battery of a pen in an electronic device according to various embodiments of the present disclosure. FIG. 17 illustrates a screen displaying a UI representing that charge is required in an electronic device according to various embodiments of the present disclosure. In the following description, an electronic device may include the entirety or a part of the electronic device 1201 illustrated in FIG. 12. A pen may include the entirety or a part of the pen 200 of FIG. 2, the pen 600 of the FIG. 6, or the pen 900 of FIG. 9.

Referring to FIG. 16, the electronic device may receive battery information of a pen (e.g. the pen 110), in operation 1601. For example, the processor 1210 of the electronic device 1201 may periodically receive the battery information of the pen through the communication module 1220 from the pen.

According to various embodiments, the electronic device may determine whether the battery power level of the pen is less than a reference battery power level (a first reference battery power level) on the basis of the received battery information, in operation 1603. For example, the processor 1210 may identify the battery power level of the pen on the basis of the received battery information. When the battery power level of the pen is less than 20%, the processor 1210 may determine that the battery power level of the pen is less than a reference battery power level. When the battery power level of the pen is equal to or greater than the reference battery power level, the processor 1210 may perform operation 1601 of receiving the battery information of the pen, again.

According to various embodiments, when the battery power level of the pen is less than the reference battery power level, in operation 1603, the electronic device may display a User Interface (UI) representing that the pen is required to be charged. For example, when the battery power level of the pen is less than 20%, the processor 1210 may control the display 1260 to display a UI 1713 representing that a pen 1720 is required to be charged on a partial region of a screen 1711 of an electronic device 1710, as shown in FIG. 17. According to an embodiment, the touch panel 1252 may include a separate charging coil configured to charge the pen in a partial region of the touch panel 1252. In this case, the processor 1210 may induce a user to contact the pen to the position of the charging coil by controlling the display 1260 to display a UI representing that the pen is required to be charged on the position of the charging coil. When the pen is in contact with the position of the charging coil of the touch panel 1252, the processor 1210 may charge the pen by applying a signal to the charging coil.

According to various embodiments, the electronic device may determine whether a specified time interval has passed, in operation 1607. For example, the processor 1210 may determine whether a time interval (e.g. one minute) configured by a user has passed after a signal is applied to the charging coil included in the touch panel 1252. When the time interval configured by a user has not passed, the processor 1210 may perform operation 1605 of controlling the display 1260 to display a UI representing that charge is required, again.

According to various embodiments, when the specified time interval has passed, in operation 1607, the electronic device may remove the UI representing that charge is required, in operation 1609. For example, when a time interval configured by a user has passed from a time point at which a signal is applied to the charging coil included in the touch panel 1252, the processor 1210 may control the display 1260 not to display the UI representing that charge is required, and then may block the signal applied to the charging coil included in the touch panel 1252, in order to charge the battery of the pen.

In the above description, when a specified time interval has passed from a time point at which a signal is applied to the charging coil, the electronic device removes a UI representing that charge is required. However, according to various embodiments of the present disclosure, the electronic device may remove the UI representing that charge is required on the basis of the battery information of the pen. For example, even after a signal is applied to the charging coil included in the touch panel 1252, the processor 1210 may continuously receive battery information of the pen through the communication module 1220. For example, the processor 1210 may identify the battery power level of the pen on the basis of the battery information of the pen. When the battery power level of the pen is equal to or greater than a second reference battery power level (e.g. 90% or greater), the processor 1210 may control the display 1260 to remove the UI representing that charge is required, and may block the signal applied to the charging coil.

According to various embodiments of the present disclosure, a pen including a battery may include: a resonance circuit unit that resonates with an electromagnetic field formed in an electronic device to output a resonance signal; a switch control unit that, when the intensity of the resonance signal exceeds the intensity of a first reference range, outputs a signal corresponding to a first level range; and a switch unit that connects the resonance circuit unit and the battery in response to reception of the signal corresponding to the first level range.

According to various embodiments, when an intensity of the resonance signal is equal to or less than the intensity of the first reference range and exceeds an intensity of a second reference range, the switch control unit may output a signal corresponding to the first level range on the basis of the intensity of the resonance signal.

According to various embodiments, when an intensity of the resonance signal is increased, the switch control unit may output a signal corresponding to the first level range.

According to various embodiments, when an intensity of the resonance signal is decreased, the switch control unit may output a signal corresponding to a second level, and the switch unit may block connection to prevent the resonance circuit unit and the battery from being connected in response to reception of the signal corresponding to the second level.

According to various embodiments, when an intensity of the resonance signal is equal to or less than the intensity of the second reference range, the switch control unit may output a signal corresponding to a second level range, and the switch unit may block connection to prevent the resonance circuit unit and the battery from being connected in response to reception of the signal corresponding to the second level.

According to various embodiments, the resonance circuit unit may include a variable capacitance changing depending on change in a pressure between the pen and the electronic device.

According to various embodiments, the pen may further include a communication circuit that provides the electronic device with information relating to a power level of the battery.

According to various embodiments of the present disclosure, an electronic device may include: a detecting sensor that includes at least one coil and generates and outputs a detecting signal according to whether a pen is housed in a housing space of the electronic device by using the at least one coil; and a processor configured to determine whether the pen is housed at least on the basis of the detecting signal of the detecting sensor, and when the pen is housed in the electronic device, apply a signal the at least one coil included in the detecting sensor to charge the pen.

According to various embodiments, the detecting sensor may include a first coil wound in a first direction and a second coil wound in a second direction opposite to the first direction.

According to various embodiments, the detecting sensor may further include a paramagnetic material that forms a path of an electromagnetic field, and the paramagnetic material may be attached to the first coil and the second coil.

According to various embodiments, when the pen is housed in the housing space of the electronic device, the at least one coil may be disposed at a location adjacent to an inductor included in the pen.

According to various embodiments, the electronic device may further include a touch panel, and the processor may be configured to: when the pen contacts the touch panel, determine whether a movement of the pen is detected; when a movement of the pen is not detected, change a time interval in which a signal is applied to at least one coil among a plurality of coils included in the touch panel; and when a specified time interval has passed after the change of the time interval in which the signal is applied to the at least one coil, restore the time interval in which the signal is applied.

According to various embodiments, the processor may be configured to, when a movement of the pen is not detected, increase a time interval in which a signal is applied to at least one coil corresponding to a point which the pen contacts among the plurality of coils.

According to various embodiments, the processor may be configured to, when a movement of the pen is detected before passage of the specified time interval, restore the time interval in which the signal is applied.

According to various embodiments, the electronic device may further include a communication module configured to periodically receive battery information of the pen.

According to various embodiments, the processer may be configured to, when a battery power level of the pen is equal to or greater than a reference battery power level before passage of the specified time interval, restore the time interval in which the signal is applied.

According to various embodiments, the electronic device may further include a display and a communication module, and the processor may be configured to: receive battery information of the pen from the pen through the communication module; when a battery power level of the pen is less than a first reference battery power level, control the display to display a User Interface (UI) representing that a battery of the pen is required to be charged; and when a specified time interval has passed after the UI representing that the battery of the pen is required to be charged is displayed, control the display to remove the UI representing that the battery of the pen is required to be charged.

According to various embodiments, the display may include, in a partial region of the display, a charging coil configured to charge the battery of the pen, and the processor may be configured to control the display to display, on a location of the charging coil, the UI representing that the battery of the pen is required to be charged.

According to various embodiments, the processor may be configured to: determine whether the pen contacts a location at which the UI representing that the battery of the pen is required to be charged is displayed; and when the pen contacts the location, apply a signal to the charging coil to charge the battery of the pen.

According to various embodiments, the processor may be configured to, when a battery power level of the pen is equal to or greater than a second reference battery power level before passage of the specified time interval, control to display to remove the UI representing that the battery of the pen is required to be charged, and block a signal applied to the charging coil.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an Application-Specific Integrated Circuit (ASIC) chip, a Field-Programmable Gate Arrays (FPGA), or a programmable-logic device, which has been known or are to be developed in the future, for performing certain operations. At least some of devices (e.g., modules or functions thereof) or methods (e.g., operations) according to various embodiments may be implemented by an instruction which is stored a computer-readable storage medium (e.g., the memory 1230) in the form of a program module. The instruction, when executed by a processor (e.g., the processor 1210), may cause the one or more processors to execute the function corresponding to the instruction. The computer-readable storage medium may include a hard disk, a floppy disk, a magnetic medium (e.g., a magnetic tape), an Optical Media (e.g., CD-ROM, DVD), a Magneto-Optical Media (e.g., a floptical disk), an internal memory, etc. The instruction may include a code made by a complier or a code that can be executed by an interpreter. The program module or the module according to the various embodiments may include one or more of the aforementioned elements or may further include other additional elements, or some of the aforementioned elements may be omitted. Operations performed by a module, a program module, or other elements according to various embodiments may be executed sequentially, in parallel, repeatedly, or in a heuristic manner. At least some operations may be executed according to another sequence, may be omitted, or may further include other operations.

The embodiments disclosed in this specification and the drawings are merely specific examples presented in order to easily describe technical details according to the embodiments of the present disclosure and to help the understanding of the embodiments of the present disclosure, and are not intended to limit the scope of the embodiments of the present disclosure. Therefore, it should be construed that, in addition to the embodiments disclosed herein, all modified and changed forms derived from the technical idea of various embodiments of the present disclosure fall within the scope of various embodiments of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A pen including a battery, the pen comprising:
a resonance circuit unit configured to resonate with an electromagnetic field formed in an electronic device to output a resonance signal;
a switch control unit configured to, when an intensity of the resonance signal exceeds an intensity of a first reference range, output a signal corresponding to a first level range; and
a switch unit configured to connect the resonance circuit unit and the battery in response to reception of the signal corresponding to the first level range.

2. The pen of claim 1, wherein, when the intensity of the resonance signal is equal to or less than the intensity of the first reference range and exceeds an intensity of a second reference range, the switch control unit is configured to output the signal corresponding to the first level range based on the intensity of the resonance signal.

3. The pen of claim 2, wherein, when the intensity of the resonance signal is increased, the switch control unit is configured to output the signal corresponding to the first level range.

4. The pen of claim 3, wherein:
when the intensity of the resonance signal is decreased, the switch control unit is configured to output a signal corresponding to a second level, and
the switch unit is configured to block a connection to prevent the resonance circuit unit and the battery from being connected in response to reception of the signal corresponding to the second level.

5. The pen of claim 2, wherein:
when the intensity of the resonance signal is equal to or less than the intensity of the second reference range, the switch control unit is configured to output a signal corresponding to a second level range, and
the switch unit is configured to block a connection to prevent the resonance circuit unit and the battery from being connected in response to reception of the signal corresponding to the second level range.

6. The pen of claim 1, wherein the resonance circuit unit includes a variable capacitance configured to change depending on a change in a pressure between the pen and the electronic device.

7. The pen of claim 1, wherein the pen further comprises a communication circuit configured to provide the electronic device with information relating to a power level of the battery.

8. An electronic device comprising:
a detecting sensor that includes at least one coil and is configured to:
generate a detecting signal according to whether a pen is housed in a housing space of the electronic device by using the at least one coil, and
output the detecting signal; and
a processor configured to:
determine whether the pen is housed at least based on the detecting signal of the detecting sensor, and
when the pen is housed in the electronic device, apply a signal the at least one coil included in the detecting sensor to charge the pen.

9. The electronic device of claim 8, wherein the detecting sensor includes a first coil wound in a first direction and a second coil wound in a second direction opposite to the first direction.

10. The electronic device of claim 9, wherein:
the detecting sensor further includes a paramagnetic material configured to form a path of an electromagnetic field, and
the paramagnetic material is attached to the first coil and the second coil.

11. The electronic device of claim 8, wherein, when the pen is housed in the housing space of the electronic device, the at least one coil is disposed at a location adjacent to an inductor included in the pen.

12. The electronic device of claim 8, further comprising a touch panel, wherein the processor is configured to:
when the pen contacts the touch panel, determine whether a movement of the pen is detected;
when the movement of the pen is not detected, change a time interval during which a signal is applied to at least one coil among a plurality of coils included in the touch panel; and
when a specified time interval has passed after the change of the time interval during which the signal is applied to the at least one coil, restore the time interval during which the signal is applied.

13. The electronic device of claim 12, wherein the processor is configured to, when the movement of the pen is not detected, increase a time interval during which a signal is applied to at least one coil corresponding to a point which the pen contacts among the plurality of coils.

14. The electronic device of claim 12, wherein the processor is configured to, when the movement of the pen is detected before passage of the specified time interval, restore the time interval during which the signal is applied.

15. The electronic device of claim 12, wherein the electronic device further comprises a communication module configured to periodically receive battery information of the pen.

16. The electronic device of claim 15, wherein the processor is configured to, when a battery power level of the pen is equal to or greater than a reference battery power level before passage of the specified time interval, restore the time interval during which the signal is applied.

17. The electronic device of claim 8, further comprising a display and a communication module, wherein the processor is configured to:
receive battery information of the pen from the pen through the communication module;
when a battery power level of the pen is less than a first reference battery power level, control the display to display a User Interface (UI) representing that a battery of the pen is required to be charged; and
when a specified time interval has passed after the UI representing that the battery of the pen is required to be charged is displayed, control the display to remove the UI representing that the battery of the pen is required to be charged.

18. The electronic device of claim 17, wherein:
the display includes, in a partial region of the display, a charging coil configured to charge the battery of the pen, and
the processor is configured to control the display to display, on a location of the charging coil, the UI representing that the battery of the pen is required to be charged.

19. The electronic device of claim 18, wherein the processor is configured to:
determine whether the pen contacts a location where the UI representing that the battery of the pen is required to be charged is displayed; and
when the pen contacts the location, apply a signal to the charging coil to charge the battery of the pen.

20. The electronic device of claim 18, wherein the processor is configured to:
when the battery power level of the pen is equal to or greater than a second reference battery power level before passage of the specified time interval, control to display to remove the UI representing that the battery of the pen is required to be charged; and
block a signal applied to the charging coil.
